(19) United States
(12) Patent Application Publication
(10) Pub. No.: US 2025/0206416 A1
(43) Pub. Date: Jun. 26, 2025

(54) Locking device for marine anti-collision ball traction rope

(71) Applicant: GUANGZHOU ISSYZONE TECHNOLOGY CO.,LIMITED, Guangzhou City (CN)

(72) Inventors: Taiping Yang, Guangzhou City (CN); Huanzhi Gong, Guangzhou City (CN); Wenhui Huang, Guangzhou City (CN)

(73) Assignee: GUANGZHOU ISSYZONE TECHNOLOGY CO.,LIMITED, Guangzhou City (CN)

(21) Appl. No.: 18/786,116

(22) Filed: Jul. 26, 2024

(30) Foreign Application Priority Data
Dec. 25, 2023 (CN) 202323550510.X

(51) Int. Cl. B63B 43/18; F16G 11/04

(52) U.S. Cl. CPC B63B 21/08; F16G 11/046; F16G 11/106

(57) ABSTRACT

The present invention discloses a locking device for a marine anti-collision ball traction rope, comprising a lock body, a rope hole, a lock cavity, a lock head and a rope guide hole. The present invention has a simple structure. By enabling the traction rope to pass through the rope hole, enabling the rope to bypass the rail and pass through the rope guide hole, and enabling the traction rope to pass through the rope locking hole, the traction rope forms a bending. The traction rope exerts a pulling force, so that the lock head swings toward the side wall of the locking cavity and realizes self-locking. The traction rope is firmly stuck on the rope locking tooth claw. The anti-collision ball can be quickly fixed on the rail; the lock head swings toward the opening of the locking cavity, and the traction rope can be pulled for length adjustment.

### REFERENCE TO PRIOR APPLICATION

This application claims priority to Chinese Patent Application 202323550510X, filed on Dec. 25, 2023, which is incorporated herein by reference.

### TECHNICAL FIELD

The present invention relates to the technical field of locking devices, in particular to a locking device for marine anti-collision ball traction rope.

### BACKGROUND

Marine anti-collision balls are specially used in certain terminals and ports. Due to the good flexibility of materials, the marine anti-collision balls can be used as buffer protection devices for yachts. The marine anti-collision balls are not easy to deform, so the marine anti-collision balls can be widely used in related industries. Marine anti-collision balls are usually hung on rails of boats via ropes when in use. At present, when an anti-collision ball is hung, a rope is usually tied to a rail of a boat, or the rope is fixed with a clasp matched with the rail. However, when the length of the rope is adjusted, the two methods are very troublesome, cannot quickly complete adjustment of the length of the rope, and seriously affect the work efficiency of boatmen. Therefore, a locking device for a marine anti-collision ball traction rope, which can not only quickly fix an anti-collision ball traction rope on the rail of a boat, but also facilitate the adjustment of the length of the traction rope, is required to be developed to improve the work efficiency of the boatmen.

### SUMMARY

The purpose of the present invention is to overcome the aforementioned defects existing in the use of existing marine anti-collision ball traction ropes, and to provide a locking device for a marine anti-collision ball traction rope which can not only quickly fix an anti-collision ball traction rope on the rail of a boat, but also facilitate the adjustment of the length of the traction rope.

The purpose of the present invention is achieved by the following technical scheme: a locking device for a marine anti-collision ball traction rope comprises a lock body, a rope hole formed in the lock body and penetrating the lock body from top to bottom, a lock cavity arranged at one end of the lock body and provided with an opening, a lock head arranged in the lock cavity and capable of swinging left and right, and a rope guide hole formed in the top of the lock body and communicating with the lock cavity; a rope locking hole is transversely formed in the movable end of the lock head and transversely penetrating the movable end of the lock head; a locking cavity is formed between the lock head and the side cavity wall of the lock cavity.

Further, the lock head is in a V shape or an L shape, and teeth are arranged on the end surface of the movable end of the lock head.

Further, a toothed plate matched with the teeth of the lock head is arranged at the lower end of the side cavity wall of the lock cavity, and the teeth and the toothed plate together form a rope locking tooth claw.

As a preferred scheme of the present invention, the rope hole is arranged vertically, or the rope hole is arranged obliquely.

Compared with the prior art, the present invention has the following advantages and beneficial effects:

The present invention has a simple structure. By enabling the anti-collision ball traction rope to pass through the rope hole from bottom to top, enabling the rope passing through the rope hole to bypass the rail and then pass through the rope guide hole, and then enabling the traction rope to pass through the rope locking hole, the traction rope between the rope guide hole and rope locking hole forms a bending. The traction rope exerts a pulling force on the lock head under the gravity of the anti-collision ball, so that the lock head swings toward the side wall of the locking cavity, and realizes self-locking under the action of pulling force. The traction rope is firmly stuck on the rope locking tooth claw formed by the teeth of the lock head and the toothed plate on the side wall of the locking cavity. The anti-collision ball can be quickly fixed on the rail; by pulling the traction rope located outside the locking cavity, the lock head swings toward the opening of the locking cavity, and the traction rope can be pulled to adjust the length, so that the present invention can quickly complete the fixation of the traction rope and length adjustment, and effectively improve the work efficiency of the boatmen.

### BRIEF DESCRIPTION OF DRAWINGS

FIG. 1 is an overall structural schematic diagram of the present invention;

FIG. 2 is a section view of the present invention;

FIG. 3 is a use exposed view of the present invention;

The names of the drawing reference signs in the aforementioned drawings are:

1—lock body, 2—rope hole, 3—rope guide hole, 4—lock head, 5—teeth, 6—rope locking hole, 7—lock cavity, 8—toothed plate.

### DETAILED DESCRIPTION OF EMBODIMENTS

The present invention will be further described in detail below in conjunction with the specific embodiments. However, the implementation of the present invention is not limited thereto.

### Embodiment 1

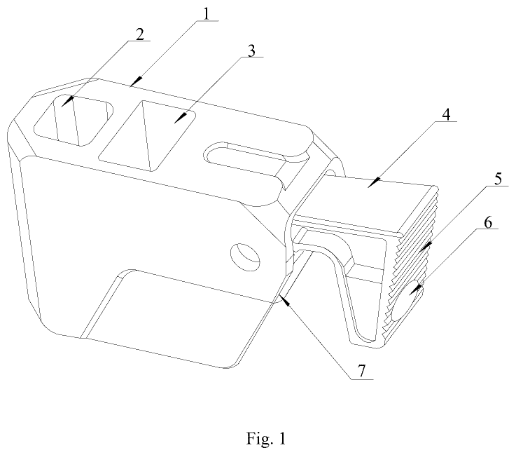

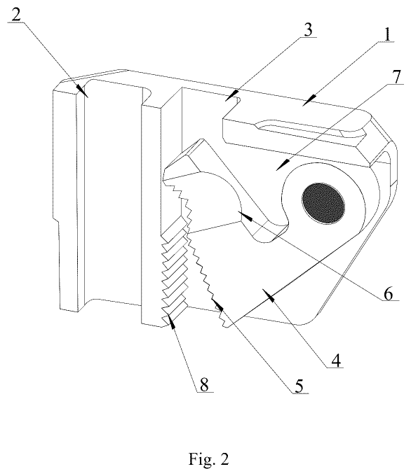

As shown in FIG. 1 and FIG. 2, the locking device for a marine anti-collision ball traction rope of the present invention comprises a lock body 1, a rope hole 2, a lock cavity 7, a lock head 4 and a rope guide hole 3. Specifically, the lock body 1 is formed in one piece or is composed of two casings. The lock body 1 in the embodiment is preferably made of plastic to effectively prevent the lock body 1 from damaging the body. A rope hole 2 is formed in the lock body 1 and penetrates the lock body 1 from top to bottom. In the specific arrangement, the rope hole 2 can be arranged vertically or obliquely, that is, the rope hole 2 can be a vertical hole or an inclined hole.

The lock cavity 7 is arranged at one end of the lock body 1. As shown in FIG. 2, the lock cavity 7 is provided with an opening, that is, the lock cavity 7 is provided with the opening sideways and downwards simultaneously. A lock head 4 is arranged in the lock cavity 7 and can swing left and right. During specific installation, the lock head 4 is mounted in the lock cavity 7 through a mounting shaft, and teeth 5 are arranged on the end surface of the movable end of the lock head 4. A toothed plate 8 matched with the teeth 5 of the lock head 4 is arranged at the lower end of the side cavity wall of the lock cavity 7, and the teeth 5 and the toothed plate 8 together form a rope locking tooth claw. The lock head 4 is mounted on the mounting shaft and can rotate freely along the mounting shaft, and the mounting shaft is horizontally mounted in pre-mounted mounting holes in the front and rear walls of the lock cavity 7. A locking cavity is formed between the lock head 4 and the side cavity wall of the lock cavity 7. A rope locking hole 6 is formed in the movable end of the lock head 4. A rope guide hole 3 is formed in the top of the lock body 1 and communicates with the lock cavity 7. Actually, the rope locking hole 6 transversely penetrates the movable end of the lock head 4, and the rope guide hole 3 is formed vertically, to ensure that the traction rope forms bending after passing through the rope guide hole 3 and the rope locking hole 6, and the traction rope can perform self-locking well under the gravity action of the anti-collision ball.

As shown in FIG. 2, the lock head 4 is in a V shape or an L shape. The lock head 4 of the embodiment is preferably in a V shape. During use, to reduce the swinging stroke of the lock head 4, and to ensure that the fixation and length adjustment of the traction rope are more convenient, the shape of the lock head 4 can be adjusted arbitrarily according to actual use needs.

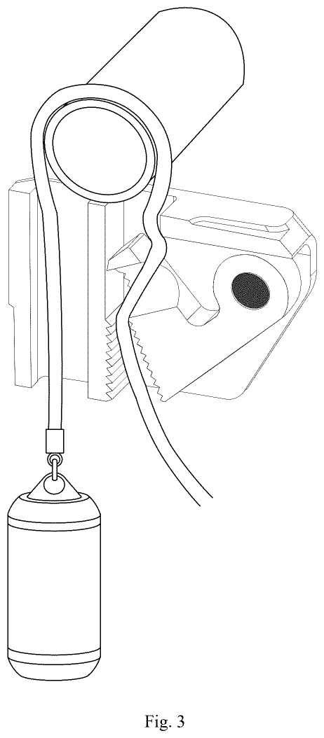

During specific use, as shown in FIG. 3, by enabling the anti-collision ball traction rope to pass through the rope hole 2 from bottom to top, enabling the rope passing through the rope hole 2 to bypass the rail and then pass through the rope guide hole 3, and then enabling the traction rope to pass through the rope locking hole 6, the traction rope between the rope guide hole 6 and rope locking hole 3 forms a bending. The traction rope passing through the rope locking hole 6 passes through the locking cavity 7 from a rope locking tooth claw formed by the teeth 5 of the lock head 4 of the device and the toothed plate 8 on the side wall of the lock cavity 7 together. At this moment, the traction rope exerts a pulling force on the lock head 4 under the gravity of the anti-collision ball, so that the lock head 4 swings toward the side wall of the locking cavity 7, and realizes self-locking under the action of pulling force. The traction rope is firmly stuck on the rope locking tooth claw formed by the teeth 5 of the lock head 4 and the toothed plate 8 on the side wall of the locking cavity 7, so that the traction rope can realize rapid self-locking, and the anti-collision ball can be quickly fixed on the rail. When the length of the traction rope is required to be adjusted, by pulling the traction rope located outside the locking cavity 7 to ensure that the lock head 4 swings toward the opening of the locking cavity 7, at this moment, the traction rope is separated from the toothed plate 8, and the traction rope can be pulled to realize the length adjustment of the traction rope, so that the present invention can quickly complete the fixation and length adjustment of the traction rope, and effectively improves the work efficiency of boatmen.

As mentioned above, the present invention can be well realized.

1. A locking device for a marine anti-collision ball traction rope, characterized by comprising a lock body (1), a rope hole (2) formed in the lock body (1) and penetrating the lock body (1) from top to bottom, a lock cavity (7) arranged at one end of the lock body (1) and provided with an opening, a lock head (4) arranged in the lock cavity (7) and capable of swinging left and right, and a rope guide hole (3) formed in the top of the lock body (1) and communicating with the lock cavity (7); a rope locking hole (6) is transversely formed in the movable end of the lock head (4) and transversely penetrating the movable end of the lock head (4); a locking cavity is formed between the lock head (4) and the side cavity wall of the lock cavity (7).

2. A locking device for a marine anti-collision ball traction rope according to claim 1, characterized in that the lock head (4) is in a V shape or an L shape, and teeth (5) are arranged on the end surface of the movable end of the lock head (4).

3. A locking device for a marine anti-collision ball traction rope according to claim 2, characterized in that a toothed plate (8) matched with the teeth (5) of the lock head (4) is arranged at the lower end of the side cavity wall of the lock cavity (7), and the teeth (5) and the toothed plate (8) together form a rope locking tooth claw.

4. A locking device for a marine anti-collision ball traction rope according to claim 1, characterized in that the rope hole (2) is arranged vertically, or the rope hole (2) is arranged obliquely.

5. A locking device for a marine anti-collision ball traction rope according to claim 2, characterized in that the rope hole (2) is arranged vertically, or the rope hole (2) is arranged obliquely.

6. A locking device for a marine anti-collision ball traction rope according to claim 3, characterized in that the rope hole (2) is arranged vertically, or the rope hole (2) is arranged obliquely.
